(19) United States
(12) Patent Application Publication
(10) Pub. No.: US 2007/0138356 A1
(43) Pub. Date: Jun. 21, 2007

(54) Display stand

(76) Inventors: Mats Johansson, Malmo (SE); Ben Lindgren, Bara (SE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/584,884

(22) PCT Filed: Dec. 27, 2004
(86) PCT No.: PCT/SE04/02015

§ 371 Date: Feb. 6, 2007

(30) Foreign Application Priority Data
Dec. 30, 2003 (SE) 0303591-2

(51) Int. Cl. F16M 11/00

(52) U.S. Cl. 248/125.1; 248/919

(57) ABSTRACT

A display stand for displays (11), comprising a pole (12) supporting the displays (11). A base plate (13) is arranged to support the pole (12), and the displays (11) are connected to a strip (45) being displaceable inside the pole in the longitudinal direction thereof, so that the displays are arranged in a row one above the other.

### FIELD OF THE INVENTION

In shops and similar establishments and environments there is a need to inform customers and passers-by about product and service offers. The invention relates to a device for displaying information, comprising at least one display stand and a transfer unit wirelessly connected to associated display stands. The display stand comprises a pole formed in a specific manner. The invention also relates to a display stand that is easy to handle.

### PRIOR ART

Printed material in the form of advertising posters and similar has been known for a long time. Lately, different types of displays have occurred, which easily can be updated and also show moving pictures. Displays showing price information are known as well as displays showing information films about the use of products.

Previously occurring displays and display systems have shortcomings when it comes to effectively conveying both advertising messages and more tangible information, such as price. The poles and mounting means used at present have shortcomings when it comes to applicability and adjustment. Consequently, there is a need for improvement of the displays and systems used today.

### SUMMARY OF THE INVENTION

An object of the invention is to avoid the above-mentioned disadvantage and provide a device for displaying information. The device comprises a display stand having a plurality of displays, e.g. in the form of flat LCD screens with colour reproduction. The display stand comprises a control unit providing different displays with different information for simultaneous display. A first group of displays, e.g. two displays, can show price information and any other information.

A second group, which also can comprise two displays, can display an advertising message, e.g. in the form of a commercial shown also in other contexts. By simultaneously showing both types of information and showing them in a direct connection to each other, conveying of information to customers and by-passers is rendered more effective. Information of different display sequences can be shown one after the other. The length and content of the sequences can be chosen freely depending on the present application.

The control unit is wirelessly connected to a transfer unit, which intermittently provides the control unit with data corresponding to the information to be shown. Inside the control unit communication means are arranged for wireless transmission of information, and memory means for storing the information to be shown during at least one display sequence. The control unit also comprises the necessary drive circuits and similar for the displays.

The display stand can be mobile and can comprise a pole supporting the displays being arranged in a row one above the other. Preferably all communication with the transfer unit is wireless, since no wiring to the display stand is required.

According to a first embodiment of the invention the transfer unit is arranged in the same premises as the display stands, or at least in the vicinity thereof. The transfer unit comprises communication means for intermittently and independently contacting and transferring information to and from a central storing unit. Suitably, communication between the transfer unit and the central storing unit is performed via the Internet. At least one set of the information to be shown during a display sequence in a plurality of display stands in different premises is stored in the central storing unit.

A transfer unit is arranged in each room provided with display stands and the transfer unit provides the control unit of each display stand with information to be shown. The control unit is passive in the sense that it does not actively contact the transfer unit. Instead a file transfer system having a powerful encryption is used. A conventional TCP/IP protocol can be used with a wire connection but preferably a wireless network, a so called WLAN (Wireless Local Area Network), is used.

The control unit is arranged to independently and continuously show different information sequences on the displays of the display stand. The showing can continue and can follow a scheme determined by the transfer unit, even though the connection with the transfer unit is interrupted.

According to a second embodiment of the invention the transfer unit is separated from the display stand and can be arranged together with the central storing unit. According to this embodiment the display stands are provided with communication means for telecommunication with the transfer unit. The telecommunication means can comprise a mobile phone or a corresponding device, and the transfer can be performed by means of GPRS (General Packet Radio Service) or any other corresponding wireless telecommunication interface.

A practical embodiment of the display stand comprises a base plate and a pole projecting from said base plate. The pole can be formed as an elongated light metal profile. A longitudinal groove is arranged in the light metal profile, in which groove a strip can run. The displays of the display stand are arranged on the strip and, thus, can be moved up and down to suitable height. The strip is provided with a lock device for locking the strip at the desired height.

According to one embodiment the pole is formed with a rectangular cross section. Three side walls are integral and one side is closable with an elongated door. The door is formed as an L-shaped light metal profile, in one end being pivotally connected with one of the side walls of the pole.

One problem with mobile display stands according to the prior art is that they are cumbersome and difficult to handle. Particularly, display stands carrying displays are difficult to handle due to the considerable weight, which can result in personal injuries as well as material damages.

Therefore, the invention also relates to a mobile display stand for displays, comprising a pole for supporting the displays and a supporting means for supporting the pole when the supporting means is resting on the ground, characterised in that a lower portion of the display stand is provided with at least one wheel being rotatable around an axle and projecting from the lower portion of the display stand in a direction perpendicular to the longitudinal direction of the pole, wherein the display stand is arranged pivotally around the axle from a first position, in which the display stand is supported by the supporting means, to a second position, in which the display stand is supported by the wheel. Hence, the wheel or a plurality of wheels is arranged so that the display stand easily and safely can be moved manually. When the display stand is supported by the supporting means, such as a base plate or similar, the display stand stands steady while undesired displacement is prevented by means of friction between the supporting means and the ground. The wheel or wheels are arranged so that they engage the ground and solely support the display stand when the pole is inclined. Hence, the pole can be pivoted while bringing the supporting means off the ground, wherein the display stand rests on the wheels for transport.

The lowermost portion of the wheels can be aligned with an underside of the display stand or somewhat above this line, so that the wheels not support the display stand when the supporting means or the base plate engages the ground. For example, the wheels are arranged at a lower edge side of the display stand, such as an edge side of the base plate, so that the wheels project somewhat from the edge side. Hence, a portion of the wheels can project from the edge side in the plane of the base plate or in a plane parallel to and somewhat above the plane of the base plate, so that the base plate not engages the ground when the display stand is inclined. Hence, the wheel can project in the plane of the base plate and beyond an edge side of the base plate.

Preferably, the pole is provided with a handle to facilitate turning the pole to the inclined position and to facilitate transport by means of the wheels. The handle can be arranged at a distance from the lower portion of the display stand and on the same side of the display stand as the wheels. For example the handle is arranged on the back of the pole, wherein the wheels project from the corresponding back of the display stand, so that the wheels are brought to support the display stand by turning the pole backwards, bringing the supporting means therewith. Alternatively, the handle and the wheels can be arranged on a front side of the display stand, i.e. the side being arranged to support the displays, or any other side.

### SHORT DESCRIPTION OF THE DRAWINGS

The invention will now be more closely described using embodiments referring to appended drawings, in which

FIG. 1 schematically illustrates a device for displaying information according to a first embodiment of the invention,

FIG. 2 schematically illustrates a device for displaying information according to a second embodiment of the invention,

FIG. 3 is a block diagram illustrating the technical functions of the device of FIG. 1,

FIG. 4 is a cross section view of a portion of a display stand according to the invention,

FIG. 5 is a schematic perspective view of a display stand according to another embodiment of the present invention, and

FIG. 6 is a schematic perspective view of a lower portion of the display stand according to FIG. 5.

### THE INVENTION

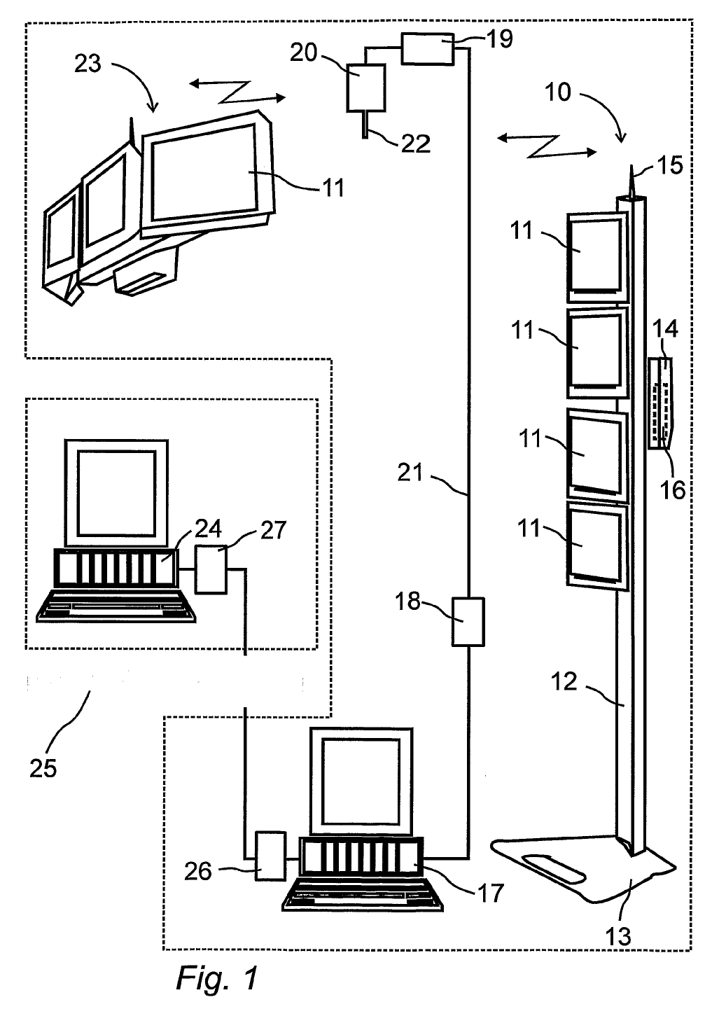

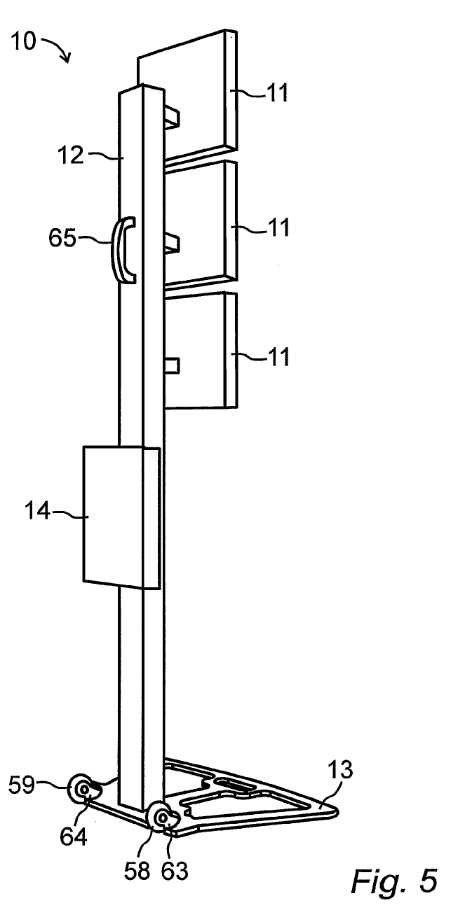

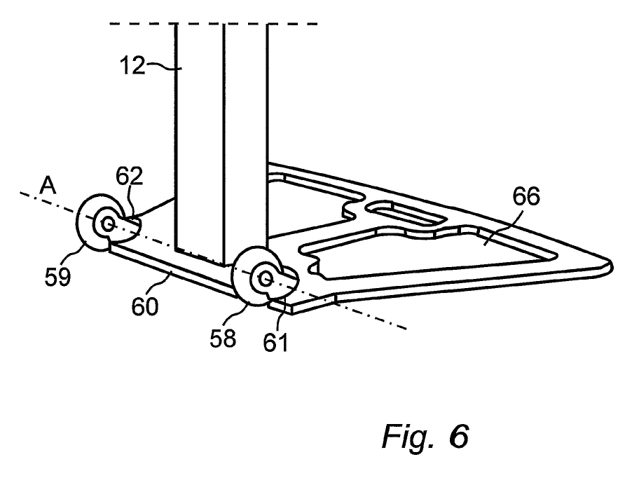

According to the embodiment of FIG. 1 a mobile display stand 10 comprises four displays 11 arranged in a row, one above the other, on a pole 12. The displays 11 are mounted on a strip being displaceable along the longitudinal direction of the pole. A bottom end of the pole is fastened to a supporting means in the form of a base plate 13 for supporting the pole. Alternatively, the supporting means is formed as a pole footing, supporting arms or similar, wherein supporting means is means for supporting the pole. One embodiment of the pole and the strip is disclosed below with reference to FIG. 4. The base plate can be provided with wheels. Suitably, the wheels are then arranged to be in contact with the floor when the pole is inclined. Transport of the pole is thus facilitated, without impairing the stability thereof when standing. The wheels are disclosed in more detail with reference to FIG. 5 and FIG. 6.

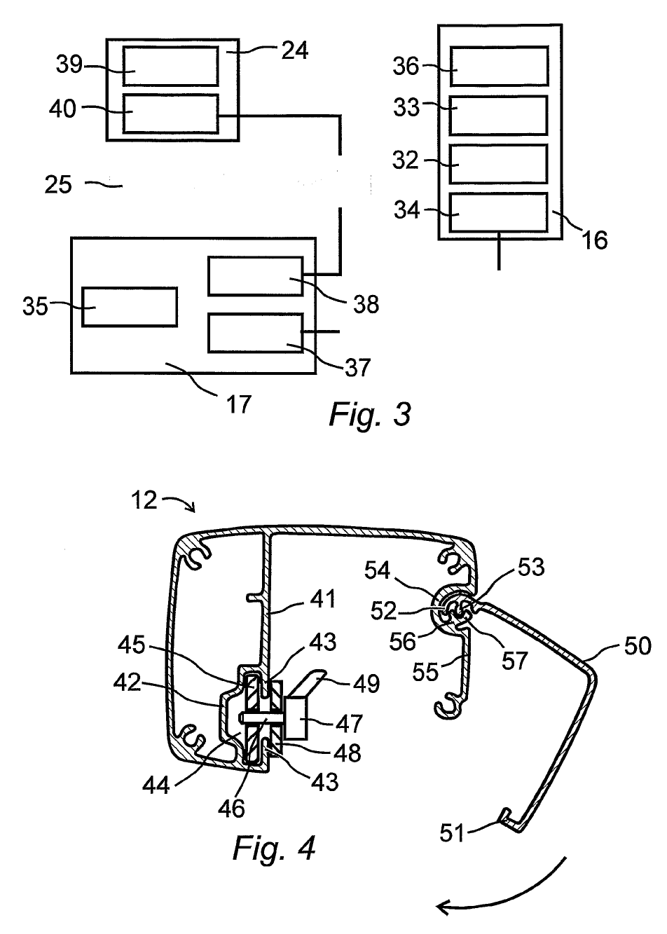

A box 14 and an antenna 15 is also arranged on the pole 12. A control unit 16 is arranged inside the box. The control unit 16 is connected to the antenna 15 and the displays 11 of the display stand 10. The control unit 16 is described further below with reference to FIG. 3. Preferably, the displays 11 are of a colour LCD type. Loudspeakers (not showed) are arranged integrated with the displays 11 or as separate loudspeakers fastened to the pole.

A transfer unit 17, which can be arranged as a conventional computer, is connected to a communication link 20 through a base unit 18 and a terminal unit 19. A conventional network cable (LAN) 21 connects the base unit 18 and the terminal unit 19. The communication link 20 can be a conventional unit for wireless network communication (WLAN) and also comprises an antenna 22.

A stationary display stand 23 can be arranged as a complement or as an alternative to the mobile display stand. Except for the pole and the base plate the stationary display stand 23 comprises the same components as the mobile display stand 10.

The transfer unit 17 is connected to a central storing unit 24. The central storing unit 24 can comprise a conventional computer and is set to store those display sequences to be displayed on the different display stands. The display sequences are available as computer files to be retrieved by different transfer units. In the embodiment of FIG. 1 the transfer unit 17 and the central storing unit 24 are separated from each other and communicate through the Internet 25 or a similar network. For security reasons the transfer unit 17 can be connected to the Internet through a first firewall 26, and the central storing unit 24 can be connected to the Internet correspondingly through a second firewall 27.

Display sequences and films are loaded through a central studio unit, in which display schemes for different display sequences also are stored. When a display scheme has been completed it can be transferred to the central storing unit 24, from which transfer units 17 can retrieve them. According to the shown embodiment the central studio unit is a part of the central storing unit 24. However, it is possible to provide the central studio unit as a separate computer.

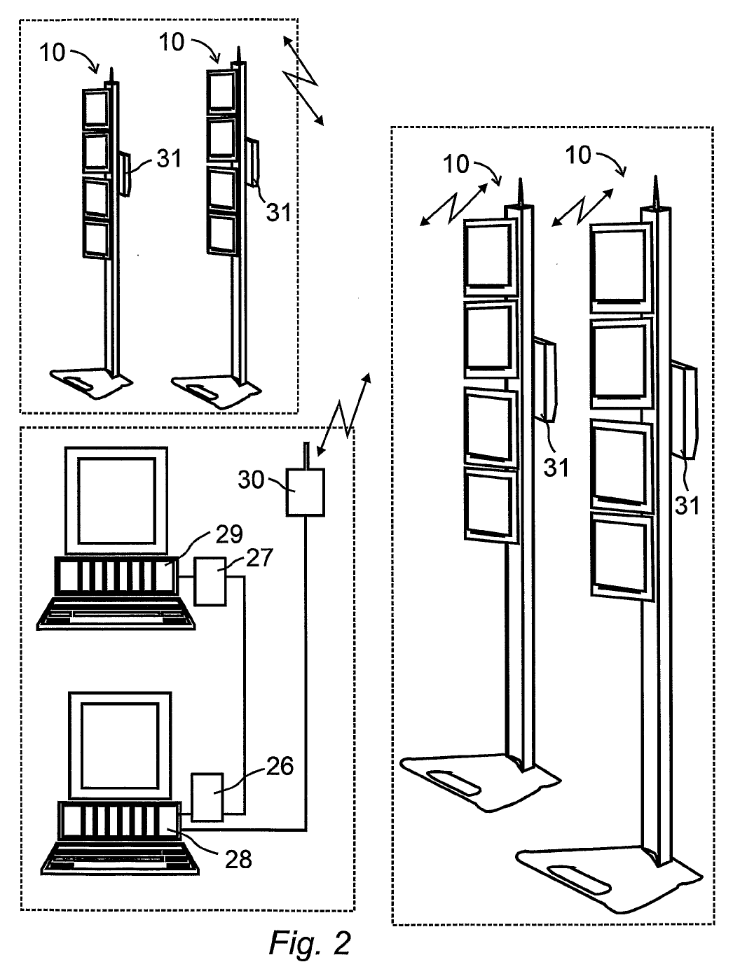

In the embodiment of FIG. 2 a transfer unit 28 is arranged together with a central storing unit 29. This embodiment of the transfer unit 28 communicates with display stands 10; 23 through a wireless telecommunication system, such as GPRS or any other corresponding wireless telecommunication interface. According to the shown embodiment the wireless telecommunication system comprises a device for mobile telecommunication 30, e.g. in the form of a mobile phone. The display stands 10; 23 are provided with a corresponding wireless telecommunication system, suitably being arranged together with a control unit 31 included in the display stand.

FIG. 3 shows by means of a block diagram how different units can be arranged. The control unit 16 comprises a computer 32 having memory means 33. A WLAN client 34, or a corresponding unit, communicates with the transfer unit 17 to receive the display sequences shown on the displays 11. The computer 32 executes a file transfer service, a so called FTP service (File Transfer Protocol), which receives films, display sequences and commands from the transfer unit 17 by means of a TCT/IP protocol. The control unit can execute its functions even though contact with the transfer unit is interrupted, functions such as playing films and starting and stopping on preset times. The control unit also comprises drive means and control means 36 for the displays connected to the control unit.

A transfer unit 17 comprises a computer 35 buffering display sequences and other data for the display stands having control units 16 and being associated with the transfer unit 17. The communication between the control unit and the transfer unit is LAN and WLAN and is protected by SSH2 encryption during login as well as during file transfer. A WLAN connection point (Access point) 37 is used for communication with the control unit of the display stand.

The computer 35 transfers all films and retrieves statistics on the control unit. This communication is initiated by the transfer unit between preset intervals. The transfer unit monitors all connected control units and maintain the correctness of date, time and any other relevant information.

In turn, the transfer unit retrieves films and commands from the central storing unit 24 in specific intervals. The communication between the transfer unit 17 and the central storing unit 24 is LAN through a first network unit 38, which normally is performed over the Internet and therefore is adapted to be able to pass through firewalls. All files and file names are encrypted, e.g. according to Rijndeal.

The central storing unit 24 comprises a computer 39 executing a FTP service where the transfer unit 17 can retrieve display sequences and films and deliver statistics. Here, also the central studio unit can deliver films and retrieve statistics. The communication between the central storing unit 24 and the transfer unit 17 is performed through a second network unit 40.

As mentioned above the central storing unit 24 and the transfer unit 17 can be arranged together. According to such an embodiment the transfer unit also comprises telecommunication means, e.g. a mobile phone or similar device.

FIG. 4 illustrates a cross section of the pole 12 and it is evident that the pole is formed by a profile. The profile is rectangular having rounded corners. A portion of one long side is open along the entire length of the pole. In connection with the open portion a partition wall 41 is arranged between the long sides of the profile. The partition wall 41 is formed with a recess 42 partially closed by two opposite tongues 43 extending in the plane of the partition wall. Inside the tongues 43 the recess forms a groove 44 extending in the longitudinal direction of the pole.

Inside the groove 44 an elongated strip 45 is arranged displaceable in the longitudinal direction of the groove. The strip 45 supports the displays 11, which thus can be moved up and down in the longitudinal direction of the pole. A lock device is arranged to enable fastening of the strip at desired height. The lock device comprises a screw 46 arranged in a threaded and through hole in the strip 45. The screw 46 is formed with a head 47, and a washer 48, having a through hole for the screw 46, is arranged between the head 47 and the tongues 43. A lock arm 49 is arranged on the head 47 to facilitate fastening of the screw 46 by screwing.

To close the open portion and hide the lock device a hinged door 50 is fastened to the profile. The door 50 is formed in an L-shape. A first end is terminated in a reclining portion 51, which delimits a slot between the partition wall and the door when closed. Attachment fittings (not showed) for the screens 11 can project from the slot. A second end of the door is terminated in a curved portion 52. A drop-shaped protrusion 53 is arranged in connection with the curved portion 52.

The curved portion 52 is pivotally received in a circular recess 54 in a side wall 55 of the profile, the side wall being parallel to the partition wall. An arm 56, having a cup-shaped end 57, projects from the circular recess 54. The cup-shaped end 57 is adapted for receiving the drop-shaped protrusion 53 of the door. The door 50 is positioned by inserting from below, before the base plate 13 is fastened to the pole, or from above. When inserting the door the curved portion 52 runs inside the circular recess 54 and the drop-shaped protrusion 53 runs inside the cup-shaped end 57 of the arm.

After insertion the door is pivotally arranged between an open position, in which the lock device with the screw 46 and the lock arm 49 is accessible, and a closed position, in which a longitudinal slot is left between the door 50 and the partition wall 41. Attachment fittings for the displays 11 can project from the slot.

According to the embodiment of FIG. 5 and FIG. 6 the display stand 10 comprises the pole 12 for supporting the displays 11, and the supporting means for supporting the pole 12 when the supporting means is in contact with the ground. The term supporting means includes a base plate, footing, supporting arms or similar means for supporting the pole 12 and, by means of friction against the ground, preventing displacement when the pole 12 is supported by the supporting means. According to the shown embodiment the supporting means is formed as a base plate 13 having an underside, a top side and edge sides. The base plate 13 is, for example, formed with openings 66 to reduce the weight of the display stand 10.

According to the embodiment of FIG. 5 and FIG. 6 the display stand is provided with wheels 58, 59 or similar rolling devices, such as at least one roll, at least one ball etc. The term wheel includes such types of rolling devices. At least one wheel 58, 59 is arranged at a lower portion of the display stand 10. For example, the display stand is provided with a first wheel 58 and a second wheel 59. The wheels 58, 59 are arranged to be in contact with the underlying floor at least when the pole 12 is inclined. Thereby, transport of the pole 12 is facilitated, without the display stand 10 being unsteady when standing.

The wheels 58, 59 are rotatable around an axle A, and project from the lower portion of the display stand 10 in a direction perpendicular to the longitudinal direction of the pole 12, wherein the display stand 10 is arranged pivotally around the axle A from a first position, in which the display stand 10 is supported by the wheels 58, 59, to a second position, in which the display stand 10 is supported by the wheels 58, 59 for transportation. Thus, the lowermost portion of the wheels 58, 59 is aligned with the underside of the display stand 10, or somewhat above this line.

For example, the lowermost portion of the wheels 58, 59 is aligned with the underside of the base plate 13, or somewhat above this line, wherein the wheels project in the plane of the base plate 13 and beyond an edge side of the base plate 13. For example, the wheels 58, 59 project somewhat from a rear edge side 60 of the base plate 13. The first wheel 58 is, according to the shown embodiment, arranged in a first aperture 61 of the base plate 13, wherein the second wheel 59 is arranged in a second aperture 62 of the base plate 13. The apertures 61, 62 are arranged in the rear edge side 60, wherein the apertures projects into the base plate 13 from the rear edge side 60, and are arranged through in a direction perpendicular to the plane of the base plate 13. The wheels 58, 59 are, for example, suspended in and connected with the display stand 10 or the base plate 13 by means of conventional wheel suspension devices 63, 64.

According to the embodiment of FIG. 5 the display stand 10 is provided with a handle 65 to be gripped by a person and facilitate turning of the display stand 10 around the axle A and facilitate transportation thereof by means of the wheels 58, 59. The handle 65 is arranged at a distance from the lower portion of the display stand 10. Thus, the pole 12 can be turned by means of the handle 65 while bringing the base plate 13 therewith, wherein the base plate 13 is disengaged from the ground and the display stand 10 instead is supported by the wheels 58, 59. For example, the handle 65 is arranged on the back of the pole 12, wherein the wheels 58, 59 project from a corresponding back of the base plate 13, so that the wheels are brought to carry the display stand 10 by turning the pole 12 backwards.

1. A display stand for displays (11), comprising a pole (12) supporting the displays (11), wherein a supporting means (13) is arranged to support the pole (12), characterised in
that the displays (11) are jointly connected to a strip (45) being displaceable inside the pole (12) in the longitudinal direction thereof, so that the displays are arranged in a row one above the other, and
that the displays are jointly supported by an attachment fitting projecting from the strip and through a longitudinal slot in the pole.

2. A display stand as claimed in claim 1, wherein the pole (12) comprises an elongated profile having a rectangular cross section, wherein a long side of the profile is arranged with an open portion along substantially the entire length of the profile and wherein a door (50) is articulately arranged on the profile for closing the opening while leaving an elongated groove.

3. A display stand as claimed in claim 2, wherein a partition wall (41) extending between the long sides of the profile is arranged with a recess (42) forming a groove (44) extending in the longitudinal direction of the profile and wherein the strip (45) is displaceable in the longitudinal direction of the groove (44).

4. A display stand as claimed in claim 3, wherein a lock device is arranged to press the strip (45) against the partition wall (41) to make height adjustment of the displays (11) possible.

5. A display stand as claimed in claim 4, wherein the lock device comprises a screw (46) being screwed into a threaded hole in the strip, and a washer (48) arranged between a head (47) of the screw (46) and the partition wall (41) and being in contact with the partition wall (41).

6. A display stand as claimed in claim 1, wherein the supporting means is formed as a base plate.

7. A display stand as claimed in claim 1, wherein a lower portion of the display stand is provided with at least one wheel being rotatable around an axle and projecting from the lower portion of the display stand in a direction perpendicular to the longitudinal direction of the pole (12), wherein the display stand is arranged pivotally around the axle of the wheel from a first position, in which the display stand is supported by the supporting means (13), to a second position, in which the display stand is supported by the wheel.

8. A display stand (10) for displays (11), comprising a pole (12) for supporting the displays (11), and a supporting means (13) for supporting the pole (12) when the supporting means (13) is resting on the ground, characterised in that a lower portion of the display stand (10) is provided with at least one wheel (58, 59) being rotatable around an axle (A) and projecting from the lower portion of the display stand (10) in a direction perpendicular to the longitudinal direction of the pole (12), wherein the display stand (10) is arranged pivotally around the axle (A) from a first position, in which it is supported by the supporting means (13), to a second position, in which it is supported by the wheel (58, 59).

9. A display stand as claimed in claim 8, wherein the lowermost portion of the wheel (58, 59) is aligned with the underside of the display stand (10).

10. A display stand as claimed in claim 8, wherein the pole (12) is provided with a handle (65) arranged at a distance from the lower portion of the display stand (10).

11. A display stand as claimed in claim 10, wherein the handle (65) is arranged on the back of the pole (12) and wherein the wheel (58, 59) projects from the corresponding back of the display stand (10), so that the wheel (58, 59) is brought to support the display stand (10) by turning the pole (12) backwards and bringing the supporting means (13) along therewith.

12. A display stand as claimed in claim 8, wherein the supporting means (13) is formed as a base plate (13) having an underside, a top side and edge sides.

13. A display stand as claimed in claim 12, wherein the wheel (58, 59) projects in the plane of the base plate (13) and beyond an edge side (60) of the base plate.

14. A display stand as claimed in claim 13, wherein an edge side (60) of the base plate (13) is provided with a through aperture (61, 62) for the wheel (58, 59), the aperture extending perpendicular to the base plate (13).
